(19) United States
(12) Patent Application Publication
(10) Pub. No.: US 2015/0169062 A1
(43) Pub. Date: Jun. 18, 2015

(54) DEVICE FOR PROVIDING HAPTIC FEEDBACK BASED ON USER GESTURE RECOGNITION AND METHOD OF OPERATING THE SAME

(71) Applicant: Electronics and Telecommunications Research Institute, Daejeon (KR)

(72) Inventors: Soon Chan PARK, Daejeon (KR); Ji Young PARK, Daejeon (KR); Kwang Hyun SHIM, Daejeon (KR); Hee Kwon KIM, Daejeon (KR); Ju Yong CHANG, Daejeon (KR); Moon Wook RYU, Seoul (KR); Hyuk JEONG, Daejeon (KR); Seung Woo NAM, Daejeon (KR); Bon Ki KOO, Daejeon (KR)

(21) Appl. No.: 14/550,835

(22) Filed: Nov. 21, 2014

(30) Foreign Application Priority Data
Dec. 13, 2013 (KR) 10-2013-0155717

(51) Int. Cl. G06F 3/01

(52) U.S. Cl. CPC G06F 3/016; G06F 3/017

(57) ABSTRACT

There are provided a device for providing haptic feedback based on user gesture recognition and a method of operating the same. The device includes a detection unit configured to detect a gesture performed by a user, a recognition unit configured to process detection information in which the user's gesture is detected by the detection unit and recognize a specific gesture performed by the user, and a control unit configured to determine whether haptic feedback information is output in consideration of the user's specific gesture recognized by the recognition unit, deliver the haptic feedback information output according to the determination result to at least one external device of a mobile terminal and a speaker, and provide haptic feedback to the user.

### CROSS-REFERENCE TO RELATED APPLICATION

This application claims priority to and the benefit of Korean Patent Application No. 10-2013-0155717, filed on Dec. 13, 2013, the disclosure of which is incorporated herein by reference in its entirety.

### BACKGROUND

1. Field of the Invention

The present invention relates to haptic feedback providing technology, and particularly, to technology for providing haptic feedback to an external device in a gesture recognition based interface capable of recognizing a user's gesture.

2. Discussion of Related Art

Haptic feedback for providing tactile feedback to a user has an effect of improving immersion for the user who uses an application. Such an effect is very important for a gesture recognition based interface where interactions occur in midair. In particular, in a user gesture recognition based interface based on computer vision among gesture recognition based interfaces, the user's gesture is estimated based on the user's gesture detection information detected by a sensor. In this case, the user's gesture is estimated based on depth information measured by a depth sensor measuring a 3D depth or color (RGB) information detected by a general RGB sensor.

However, since there is no device in contact with the user typically in such a user gesture recognition based interface, it is not possible to provide haptic feedback to the user without a separate haptic device.

In recently available user gesture recognition based interfaces, a vibration element is provided in a specific device (controller) that may be used in only a corresponding interface and haptic feedback is provided to the user by vibrating the element. Therefore, the user gesture recognition based interface may deliver haptic feedback to the user who holds a remote controller having a haptic function or wears a glove type haptic device having a haptic function.

However, since a specific device (haptic device) should always be provided with an interface in a conventional user gesture recognition based interface, interface developers or users always need to buy the haptic device and the interface should also be provided. Therefore, the conventional user gesture recognition based interface has a problem in that a development cost increases when a haptic feedback service is implemented and developed and it is inefficient.

In addition, an interface installed in public places such as a user gesture recognition based digital signage system runs a risk of damage to or theft of the haptic device. Further, the conventional user gesture recognition based interface requests that the user hold or wear the haptic device provided near the interface, which results in a decrease in convenience for the user.

### SUMMARY OF THE INVENTION

The present invention provides a technological method capable of providing haptic feedback to a user without a haptic device dedicated to a user gesture recognition based interface.

According to an aspect of the present invention, there is provided a device for providing haptic feedback based on user gesture recognition. The device includes a recognition unit configured to recognize a user's specific gesture; and a control unit configured to determine whether haptic feedback information is output in consideration of the specific gesture, deliver the haptic feedback information output according to the determination result to an external device, and provide haptic feedback to the user.

Here, the haptic feedback information may include haptic feedback intensity information and haptic feedback time information. The control unit may control an application according to the user's specific gesture recognized by the recognition unit and determine whether the haptic feedback information is output according to control of the application.

As an example, when the external device is a mobile terminal, the mobile terminal may be the user's mobile communication terminal, and the mobile terminal may include a vibration element therein.

In addition, the control unit may receive at least one piece of information of acceleration information, user input information, unique identification information, and access information from the mobile terminal via wireless communication, use the information to control the application, and transmit at least one piece of information of the user's gesture information and the user's body part location information to the mobile terminal via wireless communication.

As another example, when the external device is a speaker, the speaker may be at least one low frequency speaker (woofer) installed at a predetermined location near the user such that the speaker is included in a detection region of the detection unit along with the user.

Further, the detection unit may include at least one sensor of a structured-light type depth sensor, a time of flight (ToF) type depth sensor, a stereo type depth sensor, and an RGB sensor.

According to another aspect of the present invention, there is provided a method of providing haptic feedback in a device for providing haptic feedback based on user gesture recognition. The method includes detecting a gesture performed by the user, recognizing the user's gesture by processing the detection information, determining whether haptic feedback information is output according to the user's recognized gesture, and delivering the haptic feedback information to an external device according to the determination result, and further includes controlling an application according to the user's recognized gesture.

As an example, the delivering may include delivering the haptic feedback information to the user's mobile terminal including a vibration element therein, the controlling may include receiving at least one piece of information of acceleration information, user input information, unique identification information, and access information from the mobile terminal via wireless communication and using the information to control the application, and may further include transmitting at least one piece of information of the user's gesture information and the user's body part location information to the mobile terminal via wireless communication.

As another example, the delivering may include delivering the haptic feedback information to at least one low frequency speaker installed at a predetermined location near the user such that the speaker is detected along with the user.

In addition, the detecting may include detecting the gesture performed by the user using at least one sensor of a structured-light type depth sensor, a ToF type depth sensor, a stereo type depth sensor, and an RGB sensor, and include transmitting the haptic feedback information including at least one piece of information of haptic feedback intensity information and haptic feedback time information.

### BRIEF DESCRIPTION OF THE DRAWINGS

The above and other objects, features and advantages of the present invention will become more apparent to those of ordinary skill in the art by describing in detail exemplary embodiments thereof with reference to the accompanying drawings, in which:

FIG. 1 is a block diagram illustrating a device for providing haptic feedback based on user gesture recognition according to an embodiment of the present invention;

FIG. 2 is a diagram illustrating an exemplary case in which an external device is a mobile terminal according to the present invention;

FIG. 3 is a diagram illustrating an exemplary case in which the external device is a speaker according to the present invention; and

FIG. 4 is a flowchart illustrating a method of providing haptic feedback by a device for providing haptic feedback based on user gesture recognition according to an embodiment of the present invention.

FIG. 5 is block diagram illustrating a computer system for the present invention.

### DETAILED DESCRIPTION OF EXEMPLARY EMBODIMENTS

Advantages and features of the present invention, and methods of achieving the same will be clearly understood with reference to the accompanying drawings and the following detailed embodiments. However the present invention is not limited to the embodiments to be disclosed, but may be implemented in various different forms. The embodiments are provided in order to fully explain the present invention and fully explain the scope of the present invention for those skilled in the art. The scope of the present invention is defined by the appended claims. Meanwhile, the terms used herein are provided to only describe embodiments of the present invention and not for purposes of limitation. Unless the context clearly indicates otherwise, the singular forms include the plural forms. It will be understood that the terms “comprises” or “comprising” when used herein, specify some stated components, steps, operations and/or elements, but do not preclude the presence or addition of one or more other components, steps, operations and/or elements.

Hereinafter, exemplary embodiments of the present invention will be described in greater detail with reference to the accompanying drawings. First, when reference numerals are assigned to components in each drawing, like numbers are assigned to like elements as much as possible even though shown in different drawings. In addition, in descriptions of the present invention, when detailed descriptions of related well-known configurations or functions are deemed to unnecessarily obscure the gist of the present invention, detailed descriptions thereof will be omitted.

A device for providing haptic feedback based on user gesture recognition according to an embodiment of the present invention provides haptic feedback to a user who does not wear an additional haptic device using his or her own mobile terminal. A device for providing haptic feedback based on user gesture recognition according to another embodiment of the present invention provides haptic feedback to the user through a speaker located near the user without holding an additional haptic device by hand or separately wearing or attaching the additional haptic device.

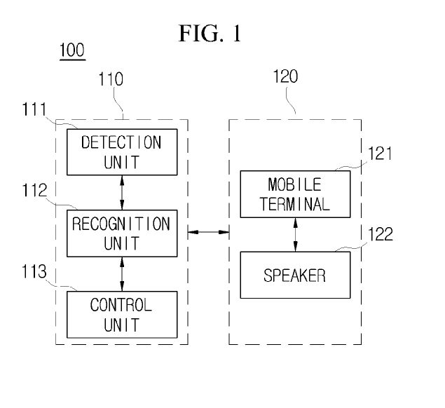

FIG. 1 a block diagram illustrating an entire system including a device for providing haptic feedback based on user gesture recognition according to an embodiment of the present invention.

As illustrated in FIG. 1, a device for providing haptic feedback based on a user gesture recognition 100 includes a gesture recognition interface 110 configured to recognize a user's gesture and an external device 120 configured to provide haptic feedback.

The gesture recognition interface 110 is configured to recognize the user's gesture, determine whether haptic feedback information is provided, and deliver the haptic feedback information, and may be a computer device. Here, the gesture recognition interface 110 includes a detection unit 111, a recognition unit 112, and a control unit 113.

The detection unit 111 is configured to obtain detection information that may be used for user gesture recognition, and is a sensor that is installed at a predetermined location in order to detect a gesture performed by the user. In this case, the user is in a predetermined region (detection region) facing the detection unit 111 such that the user is included in a detection region to be detected by the detection unit 111 and may perform a specific gesture for controlling an application.

The detection unit 111 is at least one sensor of a depth sensor and an RGB sensor, and detects a gesture performed by the user. When the detection unit 111 is, for example, the depth sensor, at least one depth sensor of an active type depth sensor and a passive type depth sensor may be used. The active type depth sensor may be a structured-light type depth sensor or a time of flight (ToF) type depth sensor. In addition, the passive type depth sensor may be a stereo type depth sensor.

Unlike the other components (the recognition unit 112 and the control unit 113), the detection unit 111 may be implemented physically separately from the gesture recognition interface 110. Also, the detection unit 111 may also be implemented as a module in the gesture recognition interface 110 along with the other components (the recognition unit 112 and the control unit 113).

The detection unit 111 may be included and implemented in a camera device configured to capture the user's gesture that is installed in the gesture recognition interface 110. In this case, a captured image captured by the camera may include detection information.

The recognition unit 112 is configured to recognize the user's gesture and includes an information processing algorithm for recognizing the user's gesture using the detection information obtained by the detection unit 111. For example, the recognition unit 112 receives the detection information including the user's gesture detected by the detection unit 111 and performs information processing, and identifies whether the user performs a specific gesture in real time.

When the detection unit 111 is included and implemented in the camera device, the recognition unit 112 performs image processing on the captured image received from the camera device, extracts detection information, and recognizes the user's gesture using the extracted detection information. In this case, the recognition unit 112 may extract detection information from the captured image using an image processing algorithm.

Here, the specific gesture refers to a gesture used for the control unit 113 to control an application later and is a predetermined gesture. For example, the specific gesture refers to a gesture performed by the user such as a gesture of tilting or turning the face in a direction, a gesture of elevating an arm (the left arm, the right arm, or both arms), and a gesture of turning a body in a direction. Such a specific gesture may be recognized through the information processing and the image processing algorithm of the recognition unit 112. A plurality of pieces of information on the specific gesture may be stored in a memory. In addition, control information for controlling the application responding to each of the plurality of specific gestures may be stored in the memory.

When it is identified that the user has performed the specific gesture, the recognition unit 112 delivers gesture information of the specific gesture performed by the user to the control unit 113.

The control unit 113 is configured to perform overall control of the gesture recognition interface 110. The control unit 113 controls the application according to the gesture performed by the user, outputs haptic feedback information, and delivers the information to the external device 120.

When it is identified by the recognition unit 112 that the user has performed the specific gesture and resulting gesture information is received, the control unit 113 controls the application according to the received gesture information. In this case, the control unit 113 may control the application using the control information stored in the memory corresponding to the received gesture information.

Here, the application is a gesture recognition based program that is controlled by the user's gesture. For example, the application may include a gesture recognition based game program, a file search program such as Windows explorer, and a map navigation program such as Google Earth.

In addition, the control unit 113 determines whether haptic feedback information is output according to the application to be controlled or the gesture performed by the user. According to the determination result, the control unit 113 delivers the haptic feedback information to the external device 120 and provides haptic feedback to the user. In this case, the haptic feedback information may include operation intensity information and operation time information of the haptic feedback.

In addition, information included in the haptic feedback information output from the control unit 113 may be changed according to a type of the external device 120. Here, the external device 120 may include at least one of a mobile terminal 121 and a speaker 122. In this case, when the external device 120 is the speaker 122, the haptic feedback information may further include haptic feedback generation location information.

As an example, the external device 120 may be the mobile terminal 121. The mobile terminal 121 is a terminal having a size that may be easily carried by the user and includes a vibration element for vibration generation. The mobile terminal 121 receives the haptic feedback information from the gesture recognition interface 110 and provides haptic feedback to the user by operating the vibration element according to the received haptic feedback information.

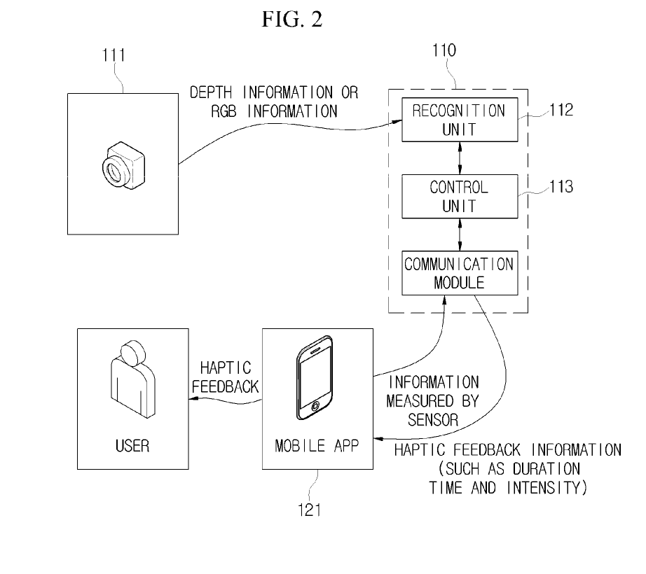

As illustrated in FIG. 2, the mobile terminal 121 may be a mobile communication terminal (for example, a smartphone) that the user owns or possesses. The gesture recognition interface 110 may store information (for example, unique identification information) on the mobile terminal 121 held by the user and may be connected to the mobile terminal 121 through a pre-stored connection operation. Also, the gesture recognition interface 110 may be connected to the mobile terminal 121 held by the user by a separate connection manipulation by the user.

The mobile terminal 121 may include a communication module configured to transmit and receive information with the control unit 113 of the gesture recognition interface 110. For example, the mobile terminal 121 may transmit and receive information with the gesture recognition interface 110 using an information transmission and reception application that is installed for information transmission and reception. In this case, the mobile terminal 121 may transmit and receive information with the control unit 113 of the gesture recognition interface 110 via wireless communication such as a data communication network, WiFi, Bluetooth, and NFC. For this purpose, the gesture recognition interface 110 may also include a communication module for wireless communication.

According to the determination result of outputting the haptic feedback information of the control unit 113, the haptic feedback information is delivered to the mobile terminal 121 via wireless communication. The mobile terminal 121 may generate a vibration according to the received haptic feedback information and provide haptic feedback to the user.

Meanwhile, the control unit 113 may deliver information on the user's specific gesture recognized by the recognition unit 112, location information of the user's body part (for example, the head, hands, and feet), and the like in addition to the haptic feedback information to the mobile terminal 121. These pieces of information may also be used for the application separately operated in the mobile terminal 121.

On the other hand, the control unit 113 may receive information obtained by the mobile terminal 121 and use the information to control the application. For example, the control unit 113 may receive acceleration information and user input information from the mobile terminal 121. Here, the acceleration information may be an acceleration value detected by an acceleration sensor embedded in the mobile terminal 121. The user input information may be information (for example, an interaction result value such as pressing a button and drawing a circle) input by the user using a user input method of the mobile terminal 121 such as a touch screen.

In addition, the control unit 113 may also receive information necessary for controlling the application such as the user holding the mobile terminal 121, unique identification information (ID information) of the mobile terminal 121, current access condition information, and the like from the mobile terminal 121.

In this manner, the control unit 113 controls the application using information on the user's gesture recognized by the recognition unit 112. In addition, when haptic feedback is necessary according to control of the application, the control unit 113 transmits the haptic feedback information to the mobile terminal 121 through the communication module.

In some cases, the control unit 113 may control the application using information received from the mobile terminal 121 in addition to information on the user's gesture recognized by the recognition unit 112. When haptic feedback is necessary according to control of the application, the control unit 113 transmits the haptic feedback information to the mobile terminal 121 through the communication module.

In this case, the haptic feedback information delivered to the mobile terminal 121 includes operation intensity information and operation time information of the haptic feedback. For example, the operation intensity information of the haptic feedback may include a level of an operation (vibration) intensity of the haptic feedback that is divided into a predetermined number according to a strength of vibration, and the operation time information of the haptic feedback may include a predetermined time (seconds) at which haptic feedback (vibration) needs to be generated.

The mobile terminal 121 that has received the haptic feedback information may activate the embedded vibration element and generate a vibration according to the operation intensity information and the operation time information of the haptic feedback included in the haptic feedback information. Accordingly, the user may receive haptic feedback, that is, vibration, through the mobile terminal 121 in contact with the user's body (that the user is holding).

In this manner, according to the embodiment of the present invention, the user may receive haptic feedback (haptic interface) using his or her mobile terminal without separately wearing an additional haptic device. Developers need not perform development of an additional connection with a specific haptic device in addition to development of a gesture recognition based computer program.

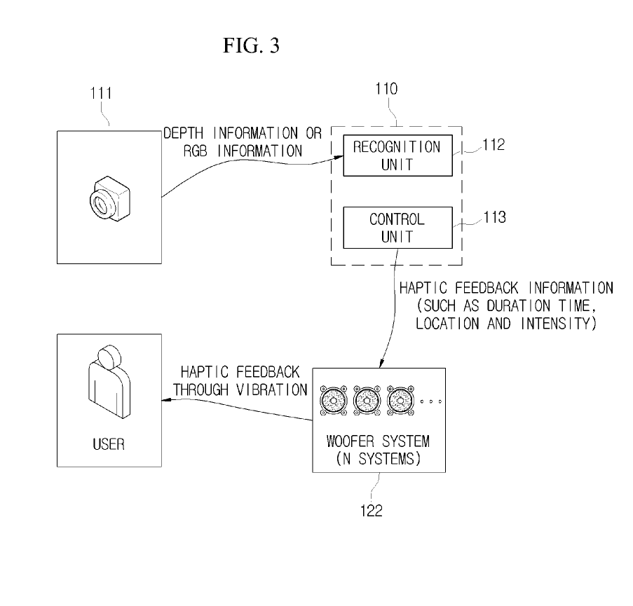

As another example, the external device 120 may be the speaker 122. Here, as illustrated in FIG. 3, the speaker 122 is at least one speaker installed at a predetermined location near the user. In this case, the speaker 122 may be installed to be included in a detection region to be detected by the detection unit 111. The speaker 122 may be connected to the gesture recognition interface 110 via wired or wireless communication and transmit and receive information.

According to the determination result of outputting the haptic feedback information of the control unit 113, the haptic feedback information is delivered to the speaker 122 via wireless communication. The speaker 122 may operate according to the received haptic feedback information and provide haptic feedback to the user. In this case, the speaker 122 is a low frequency speaker (woofer). This is because, when a low sound is generated in the low frequency speaker, the user may feel a corresponding low sound tactually and receive haptic feedback.

When the number of speakers 122 is one, the haptic feedback information includes haptic feedback intensity information and haptic feedback time information. When there are a plurality of speakers 122 (two or more), the haptic feedback information further includes vibration generation location information of the haptic feedback, and includes haptic feedback intensity information and haptic feedback time information corresponding to the vibration generation location. Also, when there are the plurality of speakers, the haptic feedback information includes haptic feedback intensity information and haptic feedback time information corresponding to each speaker.

Hereinafter, a case in which the speaker 122 is located to the right and the left (a location detected along with the user) with respect to the user will be exemplified.

As an example, when the haptic feedback information received from the control unit 113 includes haptic feedback generation location information of the right speaker, haptic feedback intensity information of a level of 10, and haptic feedback time information of 5 seconds, the speaker 122 operates (generates a low frequency) the right speaker for 5 seconds at a level of 10 and allows the user to feel a vibration from the right such that haptic feedback may be delivered through the speaker.

As another example, when the haptic feedback information received from the control unit 113 includes haptic feedback generation location information of the right and left speakers, haptic feedback intensity information of a level of 10 and haptic feedback time information of 5 seconds corresponding to the right speaker, and haptic feedback intensity information of a level of 3 and haptic feedback time information of 5 seconds corresponding to the left speaker, the speaker 122 operates the right speaker for 5 seconds at a level of 10, operates the left speaker for 5 seconds at a level of 3, and allows the user to feel more vibration from the right such that haptic feedback having directionality may be delivered.

In this manner, the gesture recognition interface 110 may provide various types of haptic feedback according to the number of the speakers 122, a disposition location thereof, and the like using the haptic feedback information.

In this manner, according to another embodiment of the present invention, the user may receive haptic feedback through the speaker located near the user without holding an additional haptic device by hand or separately wearing or attaching the additional haptic device. Therefore, it is possible to improve convenience and immersion for the user.

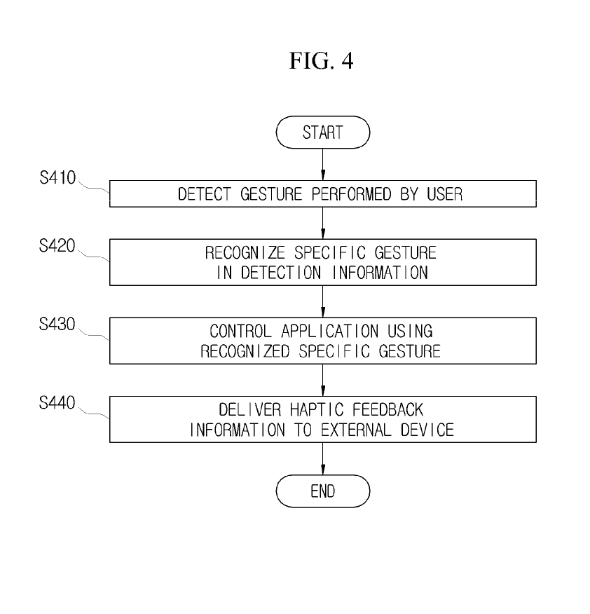

FIG. 4 is a flowchart illustrating a method of providing haptic feedback by a device for providing haptic feedback based on user gesture recognition according to an embodiment of the present invention.

In S410, the gesture recognition interface 110 detects a gesture performed by the user using a sensor.

Here, the sensor is a sensor that is installed at a predetermined location in order to detect a gesture performed by the user and is at least one sensor of the depth sensor and the RGB sensor. In addition, the user is in a predetermined region facing the sensor such that the user is included in a detection region to be detected by the sensor and may perform a gesture (a specific gesture) for controlling the application.

For example, when the sensor is included and implemented in the camera device configured to capture the user, the camera device captures a gesture performed by the user and obtains the captured image. The obtained capture image may include detection information detected by the sensor. That is, the gesture recognition interface 110 may obtain detection information including the gesture performed by the user detected by the sensor.

In S420, the gesture recognition interface 110 recognizes a specific gesture performed by the user through detection information in which the user is detected by the sensor.

The gesture recognition interface 110 performs information processing on the detection information received from the sensor using an information processing algorithm and identifies whether the user performs a specific gesture in real time. For example, when a capture image is obtained from the camera device including the sensor, the gesture recognition interface 110 performs image processing on the captured image using the image processing algorithm and may extract detection information included in the captured image.

Here, the specific gesture refers to a gesture used to control the application later and is a predetermined gesture. For example, the specific gesture refers to a gesture performed by the user such as a gesture of tilting or turning the face in a direction, a gesture of elevating an arm (the left arm, the right arm, or both arms), and a gesture of turning a body in a direction. Such a specific gesture may be recognized through the image processing algorithm, and a plurality of pieces of information on the specific gesture may be stored in a memory.

In S430, the gesture recognition interface 110 controls the application using the user's recognized specific gesture.

The gesture recognition interface 110 may control the application by obtaining control information of the specific gesture performed by the user from the memory. Here, the application is a gesture recognition based program controlled according to the user's gesture. For example, the application may include a gesture recognition based game program, a file search program such as Windows explorer, and a map navigation program such as Google Earth.

In S440, the gesture recognition interface 110 delivers the haptic feedback information to the external device 120.

The gesture recognition interface 110 determines whether haptic feedback information is output and delivers the haptic feedback information to the external device 120 according to the determination result

As an example, the gesture recognition interface 110 may output the haptic feedback information according to the specific gesture performed by the user regardless of an operation of the application that is controlled by the user's recognized specific gesture. In this case, the haptic feedback information corresponding to a plurality of specific gestures may be stored in the memory. The gesture recognition interface 110 may obtain the haptic feedback information corresponding to the user's recognized specific gesture from the memory and deliver the information to the external device 120.

As another example, the gesture recognition interface 110 may output the haptic feedback information according to a control operation of the application in response to the user's specific gesture. In this case, the haptic feedback information may be stored in the memory according to each of a plurality of control operations of a plurality of applications. The gesture recognition interface 110 may obtain the haptic feedback information corresponding to the control operation of the application from the memory and deliver the information to the external device 120.

Here, the haptic feedback information may include operation intensity information of the haptic feedback and operation time information of the haptic feedback. In this case, information included in the output haptic feedback information may be changed according to a type of the external device 120. The operation intensity information of the haptic feedback may be a level that is divided into a predetermined number according to a strength of a vibration, and the haptic feedback time information may be a predetermined time (seconds) at which a vibration needs to be generated.

Meanwhile, the external device 120 may include at least one of the mobile terminal 121 and the speaker 122. When the external device 120 is the speaker 122, the haptic feedback information may further include haptic feedback generation location information. The external device 120 may provide haptic feedback to the user using the haptic feedback information received from the gesture recognition interface 110.

As an example, the external device 120 may be the mobile terminal 121. Here, the mobile terminal 121 may be a mobile communication terminal (for example, a smartphone) that the user owns or possesses, and preferably, may be a handheld mobile communication terminal. In addition, the mobile terminal 121 includes a vibration element for vibration generation.

The gesture recognition interface 110 may deliver the haptic feedback information to the mobile terminal 121 via wireless communication such as a data communication network, WiFi, Bluetooth, and NFC. In this case, the haptic feedback information to be delivered includes haptic feedback intensity information and haptic feedback time information.

The mobile terminal 121 that has received the haptic feedback information may activate the embedded vibration element and generate a vibration according to haptic feedback intensity information and haptic feedback time information included in the haptic feedback information. Accordingly, the user may receive haptic feedback, that is, vibration, through the mobile terminal 121 in contact with the user's body (that the user is holding).

For example, when the haptic feedback information includes haptic feedback intensity information of a level of 10 and haptic feedback time information of 5 seconds, the mobile terminal 121 operates (activates the vibration element) the vibration element for 5 seconds at a level of 10 (strength) such that the user holding the mobile terminal 121 by hand may feel a vibration and receive haptic feedback.

As another example, the external device 120 may be the speaker 122. Here, the speaker 122 is at least one speaker that is installed at a predetermined location near the user to be detected by the sensor along with the user. Preferably, the speaker 122 is a low frequency speaker. When a low sound is generated in a low frequency speaker, the user may feel a corresponding low sound tactually and receive haptic feedback.

A case in which the speaker 122 is located to the right and the left (a location detected along with the user) with respect to the user will be exemplified.

When the haptic feedback information received from the gesture recognition interface 110 includes haptic feedback generation location information of the right and left speakers, haptic feedback intensity information of a level of 10 and haptic feedback time information of 5 seconds corresponding to the right speaker, and haptic feedback intensity information of a level of 3 and haptic feedback time information of 5 seconds corresponding to the left speaker, the speaker 122 operates the right speaker for 5 seconds at a level of 10 and the left speaker for 5 seconds at a level of 3, and allows the user to feel more vibration from the right such that haptic feedback having directionality may be delivered.

In this manner, according to the embodiment of the present invention, the user may receive haptic feedback (haptic interface) using his or her mobile terminal without separately wearing an additional haptic device. Developers need not perform development of an additional connection with a separate specific haptic device in addition to development of a gesture recognition based computer program.

In addition, according to another embodiment of the present invention, the user may receive haptic feedback through the speaker located near the user without holding an additional haptic device by hand or separately wearing or attaching the additional haptic device. Therefore, it is possible to improve convenience and immersion for the user.

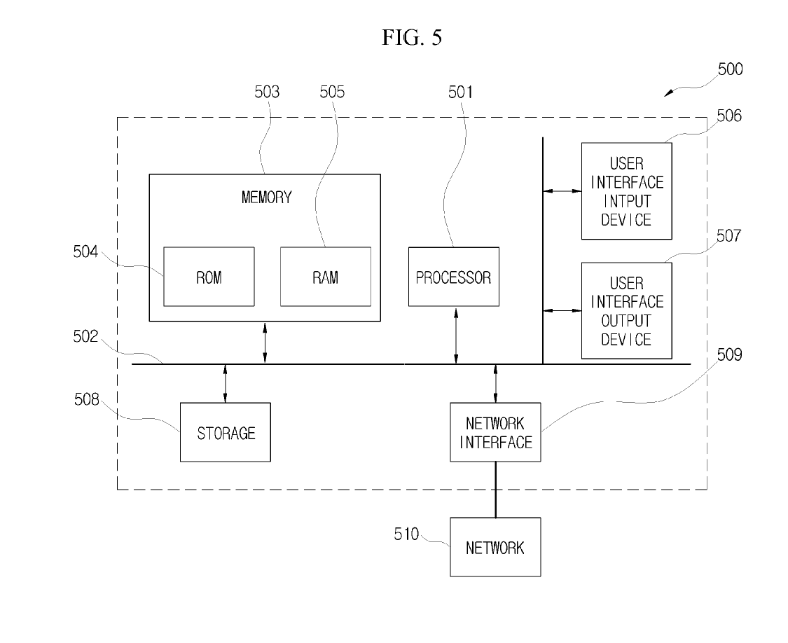

An embodiment of the present invention may be implemented in a computer system, e.g., as a computer readable medium. As shown in in FIG. 5, a computer system 500 may include one or more of a processor 501, a memory 503, a user input device 506, a user output device 507, and a storage 508, each of which communicates through a bus 502. The computer system 500 may also include a network interface 509 that is coupled to a network 510. The processor 501 may be a central processing unit (CPU) or a semiconductor device that executes processing instructions stored in the memory 503 and/or the storage 508. The memory 503 and the storage 508 may include various forms of volatile or non-volatile storage media. For example, the memory may include a read-only memory (ROM) 504 and a random access memory (RAM) 505.

Accordingly, an embodiment of the invention may be implemented as a computer implemented method or as a non-transitory computer readable medium with computer executable instructions stored thereon. In an embodiment, when executed by the processor, the computer readable instructions may perform a method according to at least one aspect of the invention.

While the configuration of the present invention has been described above with reference to the exemplary embodiments of the present invention, but it will be understood by those skilled in the art that various modifications can be made without departing from the scope of the present invention and without changing essential features. Therefore, the above-described embodiments should be considered in a descriptive sense only and not for purposes of limitation. The scope of the present invention is defined by the appended claims but by the detailed descriptions. The present invention is to cover all modifications or alternations derived from the claims and equivalents thereof.

### REFERENCE NUMERALS

| | |
|---|---|
| 100: device for providing haptic | 110: gesture recognition interface |
| feedback | |
| 111: detection unit | 112: recognition unit |
| 113: control unit | 120: external device |
| 121: mobile terminal | 122: speaker |

What is claimed is:

1. A device for providing haptic feedback based on user gesture recognition, comprising:
a recognition unit configured to recognize a user's specific gesture; and
a control unit configured to output haptic feedback information is output in consideration of the specific gesture, deliver the haptic feedback information to an external device, and provide haptic feedback to the user.

2. The device according to claim 1,
wherein the control unit outputs the haptic feedback information including operation intensity information and operation time information of the haptic feedback is output.

3. The device according to claim 1,
wherein the control unit controls an application according to the specific gesture recognized by the recognition unit and output the haptic feedback information is output according to control of the application.

4. The device according to claim 1,
wherein the external device is the user's mobile terminal including a vibration element.

5. The device according to claim 4,
wherein the control unit receives at least one piece of information of acceleration information, user input information, unique identification information, and access information from the mobile terminal via wireless communication and uses the received information to control the application.

6. The device according to claim 4,
wherein the control unit transmits at least one piece of information of the user's gesture information and the user's body part location information to the mobile terminal via wireless communication.

7. The device according to claim 1,
wherein the external device is a speaker installed at a predetermined location near the user.

8. The device according to claim 1, further comprising
a detection unit configured to obtain detection information of a gesture performed by the user included in a detection region,
wherein the recognition unit processes the detection information and recognizes the specific gesture.

9. The device according to claim 8,
wherein the detection unit includes at least one sensor of a structured-light type depth sensor, a time of flight (ToF) type depth sensor, a stereo type depth sensor, and an RGB sensor.

10. The device according to claim 8,
wherein, when the external device is a speaker, at least one speaker is installed at a predetermined location near the user such that the speaker is included in the detection region of the detection unit.

11. A method of providing haptic feedback based on user gesture recognition by a device for providing haptic feedback, the method comprising:
recognizing a specific gesture performed by a user by processing detection information in which the user is detected;
outputting haptic feedback information according to the specific gesture; and
delivering the haptic feedback information to an external device.

12. The method according to claim 11,
wherein the delivering includes
delivering the haptic feedback information including at least one piece of information of haptic feedback intensity information and haptic feedback time information to the external device.

13. The method according to claim 11, further comprising
controlling an application according to the specific gesture,
wherein, in the controlling, at least one piece of information of acceleration information, user input information, unique identification information, and access information is received from the external device via wireless communication, and the received information is used to control the application.

14. The method according to claim 11,
wherein the delivering includes
delivering the haptic feedback information to the user's mobile terminal including a vibration element therein.

15. The method according to claim 14,
wherein the delivering further includes
delivering at least one piece of information of the user's gesture information and the user's body part location information to the mobile terminal via wireless communication.

16. The method according to claim 11,
wherein the delivering includes
delivering the haptic feedback information to at least one speaker installed at a predetermined location near the user such that the speaker is detected along with the user.

17. The method according to claim 11, further comprising
obtaining the detection information by detecting the gesture performed by the user using at least one sensor of a structured-light type depth sensor, a time of flight (ToF) type depth sensor, a stereo type depth sensor, and an RGB sensor.
